(19) United States
(12) Patent Application Publication
(10) Pub. No.: US 2014/0223796 A1
(43) Pub. Date: Aug. 14, 2014

(54) Pocket Bow and Gun Rest

(71) Applicant: David M. Coonrod, Traverse City, MI (US)

(72) Inventor: David M. Coonrod, Traverse City, MI (US)

(21) Appl. No.: 14/178,771

(22) Filed: Feb. 12, 2014

Related U.S. Application Data
(60) Provisional application No. 61/764,361, filed on Feb. 13, 2013.

(51) Int. Cl. A01M 31/00; F41A 23/18; F41B 5/14

(52) U.S. Cl. CPC A01M 31/00; F41B 5/1453; F41A 23/18
USPC 42/94; 124/1

(57) ABSTRACT

A rest for a bow or gun, useful when a hunter is in a standing position. The rest comprises a generally U-shaped body sized and shaped to fit in a front or side pant pocket, and to be worn comfortably throughout a hunt or shooting session. The rest has a lower end defining a shelf of sufficient thickness to receive and support a bow's lower limb tip or cam, or a corner of a gun's butt stock, through the pocket fabric. The rest may have a substantially rigid but pliable core for adjusting the shape for a custom fit, and an outer cushioning layer for comfort and for resiliently receiving the bow or gun.

### RELATED APPLICATIONS/PRIORITY BENEFIT CLAIM

This application claims the benefit of U.S. Provisional Application No. 61/764,361, filed Feb. 13, 2013 by the same inventor (Coonrod), the entirety of which provisional application is hereby incorporated by reference.

### FIELD

The subject matter of the present application is in the field of body-supported rests for bows and firearms.

### BACKGROUND

Portable rests for resting the weight of a bow or gun while waiting for game are known to hunters. Examples include those shown in U.S. Pat. No. 5,850,955 to Barr (external pouch strapped to a leg); U.S. Pat. No. 6,021,768 to Pomaville (cup member and complementary hook strap mounted on a tree-stand seat); U.S. Pat. No. 6,267,278 to Bogart (folding bow support with lower limb/wheel receiver and bowstring retainer structure mounted to archer's calf with straps); U.S. Patent Application No. 20020053580 A1 to Charles (leg-engaging strap with bow receiving member); U.S. Patent Application No. 2003/0006259 A1 to Campana (compound bow holster with body-fitting backing plate); U.S. Pat. No. 6,523,183 to Wright et al. (trousers with external bow rest pocket on outside calf); U.S. Pat. No. 7,527,182 to Sherwood et al. (support pocket strapped to archer's calf, with open hook socket for bowstring/cable); and U.S. Patent Application No. 2011/0204113 to Reinarz et al (belt holster with ball-and-socket clip).

These prior devices are worn or fastened externally on the hunter, or must be carried to a hunting blind or stand for attachment to a support, making it more difficult for a hunter to move easily and quietly in the woods. Many appear to require complicated engagement in order to rest or holster a bow, and thus require significant movement to bring the bow to a ready position to take a shot, making it more likely that game will be spooked.

Further, the prior rests and holsters seem useful only for a hunter in a sitting position, or walking to and from a hunting location. Some interfere with walking unless adjusted or removed. Many are relatively complex, would be relatively expensive to make, and/or require special or modified clothing.

### BRIEF SUMMARY

I have invented a bow (and firearm) rest adapted to fit in the front pocket of a normal, unmodified pair of pants worn by a hunter, to remain securely and comfortably in position in the pocket regardless of activity, and to help support the weight of a bow or firearm with minimal movement while the hunter is in a standing ready position. The inventive rest comprises a generally U-shaped member sized to fit in a front pant pocket, with legs spaced widely enough, and of sufficient thickness, to form a ledge or shelf at the lower end capable of receiving and supporting a lower limb tip or cam wheel of a bow, or a lower corner of a gun's stock, through the pocket's outer fabric. “U-shaped” includes both rounded and squared U-shapes with either rounded or flattened lower ends and shelves, V-shapes, and variations.

The rest may be planar (lies flat on a table) or multi-planar. In a first form, the rest is substantially flat, i.e. the legs and lower end of the U-shaped member are parallel and generally lie in a single plane defined by the thickness of the rest. In an alternate multi-planar form, the lower end of the U-shaped member is angled outwardly relative to a plane defined by the upper legs, so that the lower end is biased outwardly against the pocket's outer fabric. Alternately, the upper ends of the legs of the U-shaped member could be angled relative to a plane defined by the lower end, producing a similar result—the lower end biased outwardly against the pocket's outer fabric.

In a further form the rest comprises a relatively rigid core and an outer resilient, cushioning layer, for example fabric, foam, or plastic dip or molding. In a preferred form, the rigid core is bendable or pliable to a degree, for a custom fit in the pocket. In a further preferred form, the rigid core has a substantially flat cross-section, while the outer cushioning layer has a more rounded cross-section.

The cross-section (or at least the outer surfaces) of the inventive rest may be flat, rounded, or a combination of flat and rounded sections or outer surfaces. Different portions of the rest may have different thicknesses and/or cross-sectional shapes, and could differ in material and construction.

The inventive rest is inserted in a pocket in an upright position, and when the hunter is standing, the lower end of a bow or firearm can be rested on ledge or shelf formed by the lower end of the rest through the pocket's outer fabric when the hunter is standing. The bow or firearm remains at the ready in front of the hunter, with a substantial portion of its weight supported by the rest/pocket combination, with minimal movement needed to bring it to a ready or firing position.

These and other features and advantages of the invention will become apparent from the detailed description below, in light of the accompanying drawings.

### BRIEF DESCRIPTION OF THE DRAWINGS

FIG. 1 is a perspective view of a bow rest according to the invention, shown in solid lines exploded from a pant pocket and in hidden lines after being inserted into the pocket, and with the lower ends of a bow and of a firearm shown in exploded view relative to the rest.

FIG. 2 is similar to FIG. 1, but shows the lower end of the bow resting on the rest through the pocket's outer fabric.

FIG. 2A is similar to FIG. 2, but shows the entire hunter in perspective, resting a bow on the rest through the pocket's outer fabric.

FIG. 3 is a perspective view of the bow rest alone, with a core shown in hidden lines.

FIG. 4 is a front elevation view of the rest of FIG. 3

FIG. 5 is a cross-section view of the rest of FIG. 3.

FIG. 6 shows an alternate V-shaped rest.

FIG. 7 shows an alternate U-shaped rest.

FIG. 8 is a schematic view, in side elevation, of a rest similar to that in FIGS. 1 through 5, but with a multi-angled shape.

FIG. 9 is a perspective view of a rest similar to that in FIG. 3, but with a flattened upper surface.

FIG. 9A is a cross-section view of the rest of FIG. 9.

### DETAILED DESCRIPTION

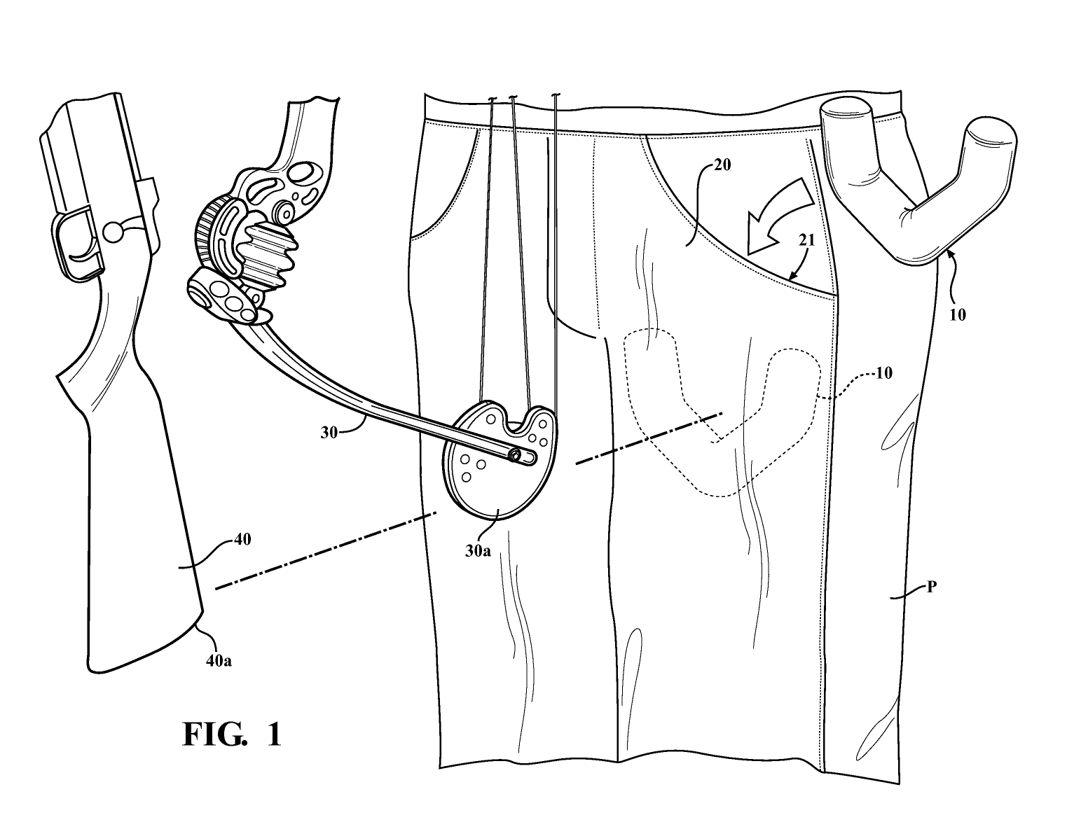

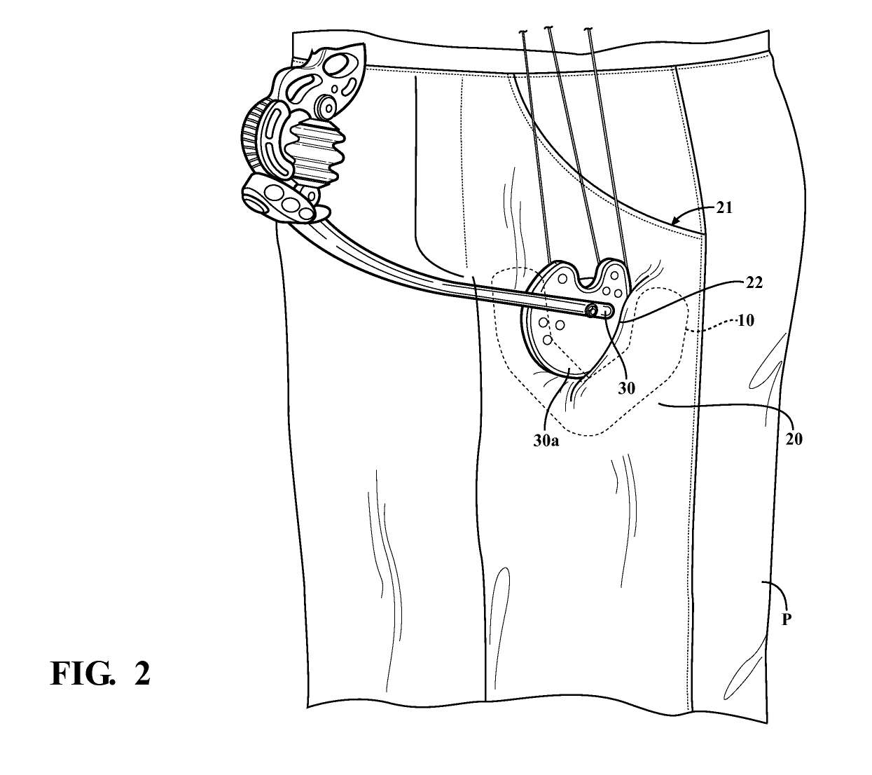

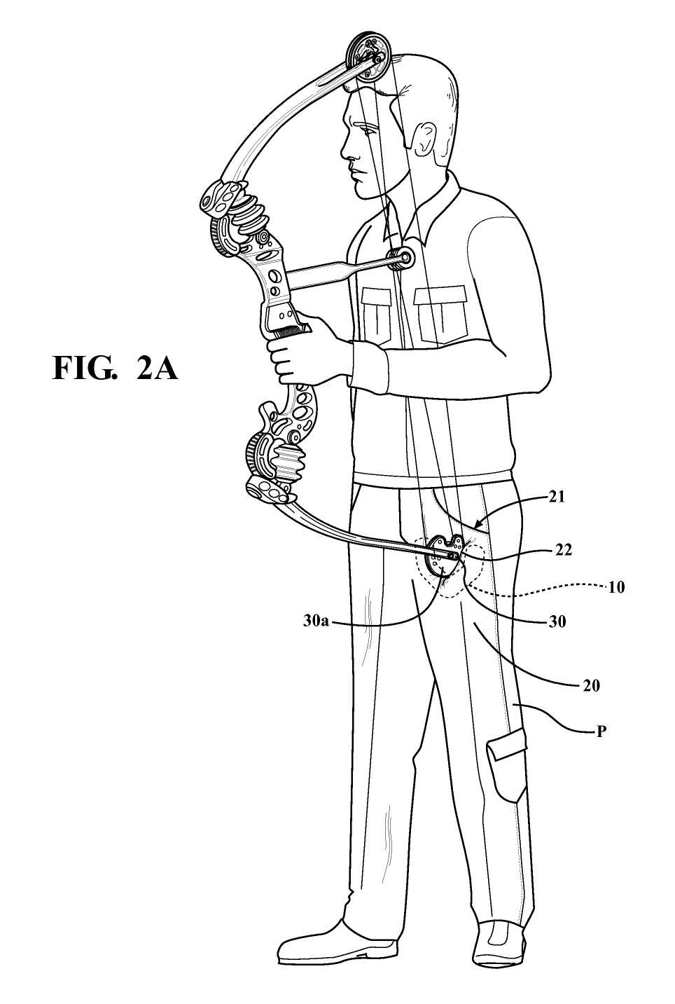

Referring first to FIGS. 1 and 2, a bow rest 10 according to the invention is shown in exemplary form in order to teach how to make and use the claimed invention. In FIG. 1 the rest 10 is shown in solid lines prior to insertion in a hunter's front pant pocket 20, and shown in hidden lines after being inserted in pocket 20. Although insertion in a front pocket is preferred, it would also be possible to insert and use rest 10 in a side or cargo pocket.

Rest 10 is generally U-shaped, with spaced legs 12 terminating in upper ends 12a, the legs connected by a lower end or bight 14 providing a shelf or ledge 14a of suitable width (between the legs) and thickness (cross-section or front-to-back depth relative to the pocket) to engage and support the lower end of a bow limb/wheel or firearm stock through the pocket fabric. Rest 10 is generally U-shaped, which includes both the rounded shape shown, as well as V-shapes (with pointed lower ends), multi-angled shapes (with flattened lower ends for a more squared U-shape), and combinations thereof. The best shape for a given rest 10 may depend on the type of bow or gun for which it is intended, and on the shape and size of the pocket for which it is intended—for example, more U-shaped for rounded or wider pockets; and more V-shaped for narrower, deeper pockets.

Pants P may be hunting-specific pants, or they could be ordinary pants such as jeans, provided pocket 20 has enough depth and volume to accommodate rest 10.

Rest 10 can be sized and shaped to fit different types and sizes of pant pocket, limited only to having sufficient width and thickness at the lower end 14 of the U-shape to provide an adequate resting shelf for a bow or firearm through the pocket fabric.

FIG. 1 shows both a lower bow limb 30 and a rifle/shotgun stock 40 in exploded relationship to rest 10, while FIGS. 2 and 2A show the lower bow limb 30 resting on the rest 10 through the outer fabric 22 of pocket 20. It will be understood by those familiar with archery and bow-hunting that bow limb lower end 30 can vary considerably depending on type of bow, make, and model. Generally, however, the lower end 30 of the bow limb will be a simple limb end or tip (for straight and recurve bows), or will include a cam wheel or eccentric such as 30a (for compound bows). Both types of lower bow limb 30 can be accommodated by rest 10, whose lower shelf portion 14a can be adapted in terms of thickness or shape to accept nearly any bow. Rifle and shotgun stocks tend to be more standard, and usually present a fairly standard corner to the rest.

Rest 10 sits comfortably in the pocket 20 whether the hunter is standing, sitting, or walking. The U-shape of rest 10, generally similar to the shape of a pocket, stabilizes the rest in the pocket in an upright position with legs 12 pointing up toward the pocket opening 21, especially when inserted to the bottom of the pocket. Rest 10 is accordingly in a position to serve as a rest whenever a hunter is standing, with rest 10 oriented in an upright and vertical position or plane in the pocket, such that lower end 14 can receive and support the weight of a bow limb or gun stock.

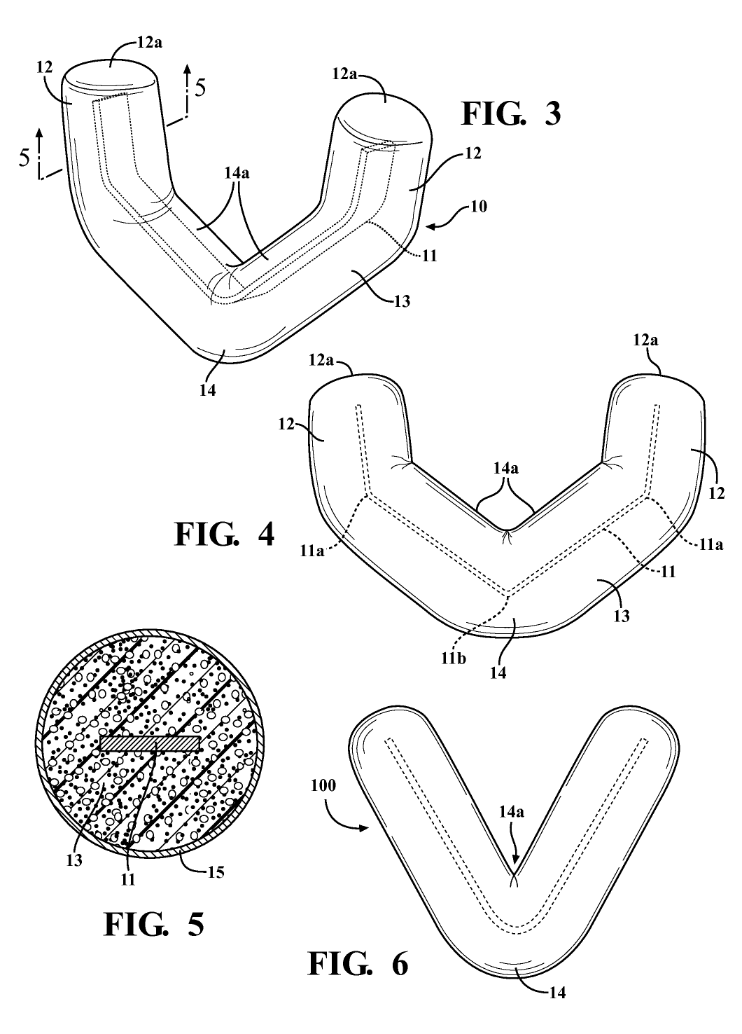

Referring to FIGS. 3, 4, and 5, illustrated rest 10 is shown by itself, with a preferred construction using a rigid core 11 and a cushioned outer layer 13. In the example of FIG. 3, core 11 is formed from a wide, flat blank of metal, bent at angles of 130° at legs 12 and at an angle of 70° at the lower end or point 14. The illustrated cushioned outer layer 13 is made from a compressible foam, by way of non-limiting example, and may be covered with an outer layer of tape, cloth, plasti-dip, or similar material with either smooth or gripping properties. The compressibility of any cushioning layer 13, and the frictional characteristics of the outer surface of the rest, may vary, for example depending on the desired ease of insertion/removal of the rest into and out of pocket 20, or the desired grip of the outer surface with respect to the outer pocket fabric or the resilience of the rest when a bow or gun is rested on rest 10 through the pocket outer fabric.

Core 11 is relatively rigid compared to cushioning layer 13, but may be bendable to take different set shapes, in order to custom fit the rest 10 to the user's pocket.

Although illustrated rest 10 in FIG. 3 shows the use of distinct materials for the core and cushioning layers 11 and 13, it will be understood that rest 10 could be made with unitary construction, i.e. from a single material. Options for both core 11 and/or a unitary material include but are not limited to plastic or metal rod or tubing, wood, dense molded foams, and plastics. Also, hybrid constructions are possible, where different parts of the rest (for example legs 12 and lower end 14) are made from different material(s), or with different cross-sectional shapes. One possible variation could be core 11 functioning as a rest on its own, without a cushioning layer such as 13.

FIG. 6 shows a more V-shaped rest 100, in which the lower end 14 and shelf 14a come to a point rather than a flat or rounded shape. A V-shaped rest such as 100 may be more suitable for pockets that narrow sharply toward the bottom, or for supporting certain narrower styles of bow limb or gun stock.

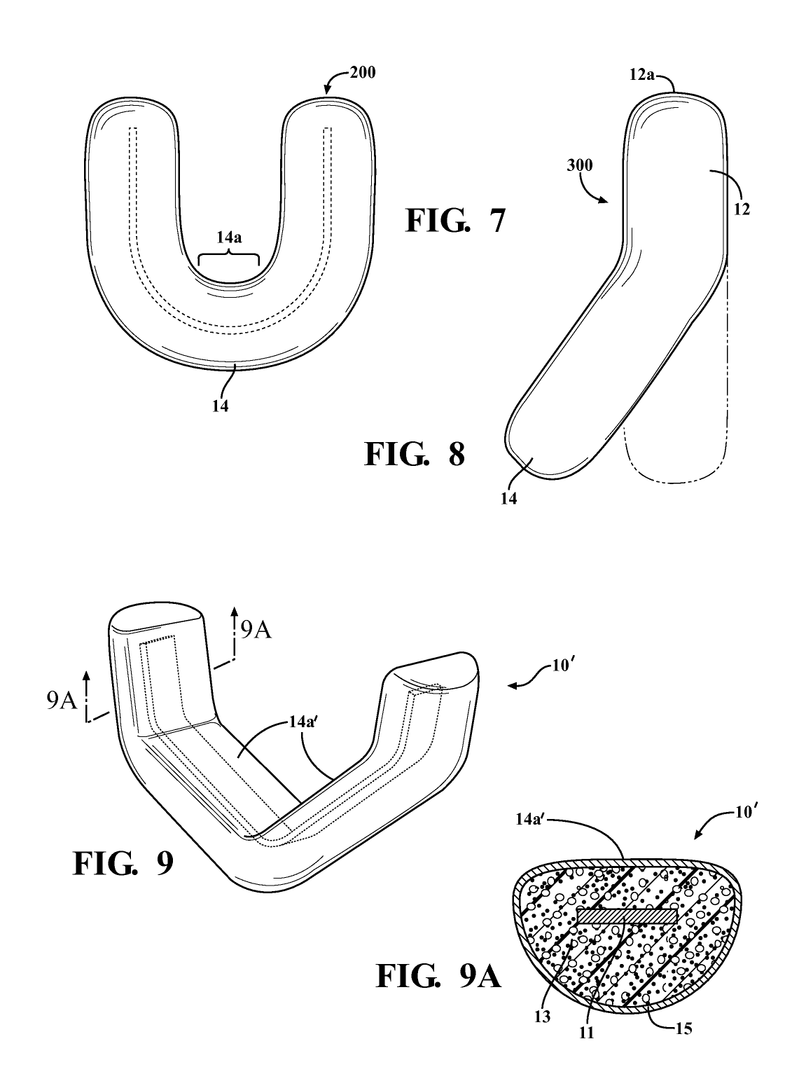

FIG. 7 shows a more rounded U-shaped rest 200, in which the lower end 14 and shelf 14a have a substantially semi-circular radius. A fully U-shaped rest such as 200 may be more suitable for more rounded pockets, or for supporting certain wider or more rounded styles of bow limb or gun stock. It is also possible to form lower end 14 and/or shelf 14a with a more squared profile relative to the legs, rather than a rounded profile, for a flatter, more horizontal lower end and/or shelf.

FIG. 8 shows a rest 300, similar to rest 10 but with its lower end 14 angled outwardly relative to legs 12, which are parallel to one another and lie in a common plane. Angling the lower end and legs relative to one another in various ways can be used to adjust the rest's fit in the pocket, and to bias the lower end 14 outwardly from the hunter's leg to provide more “shelf” or support through the pocket fabric. The angle may be something set during manufacture, or may be a custom adjustment by the hunter if rest 10 has a pliable body or core.

FIGS. 9 and 9A show a modified rest 10′, having a flattened upper surface 14a′ and a rounded lower surface 15, forming a flatter shelf surface 14a′at the lower end, which might be easier to engage through the pocket's fabric, and/or which might be more supportive for certain types of cam or bow limb tip.

### DESCRIPTION OF OPERATION

In operation, the rest 10 is inserted into a front or side pocket before or during a hunt, or before or during a target practice or range session, and used as needed when the hunter/archer/shooter is standing (FIG. 2A) to support the weight of a bow or gun in a ready position. It has been found that the rest can support most or all of the weight of a bow or gun, reducing muscle fatigue and allowing a hunter to be ready when game appears. The rest 10 does not require straps, belts, clips, or modifications to normal hunting clothing. Rest 10 is light enough to be relatively unnoticeable while hunting or hiking, is unlikely to fall out of the pocket, and resists shifting in the pocket. Yet it is extremely effective in conveniently supporting the weight of a bow or gun, in a position that is very fast for presenting the bow or gun for a shot with minimal game-spooking movement.

It will finally be understood that the disclosed embodiments represent presently preferred examples of how to make and use the invention, but are intended to enable rather than limit the invention. Variations and modifications of the illustrated examples in the foregoing written specification and drawings may be possible without departing from the scope of the invention. It should further be understood that to the extent the term “invention” is used in the written specification, it is not to be construed as a limiting term as to number of claimed or disclosed inventions or discoveries or the scope of any such invention or discovery, but as a term which has long been conveniently and widely used to describe new and useful improvements in science and the useful arts. The scope of the invention supported by the above disclosure should accordingly be construed within the scope of what it teaches and suggests to those skilled in the art, and within the scope of any claims that the above disclosure supports in this provisional application or in any non-provisional application claiming priority to this provisional application.

What is claimed:

1. A rest for a bow or gun in a standing position, comprising:
a generally U-shaped body comprising a lower end connecting two spaced upright legs, the rest sized and shaped to fit in a front or side pant pocket in an upright position, the lower end having a thickness and width sufficient to form a shelf capable of receiving and supporting a lower limb of a bow or a gun stock.

2. The rest of claim 1, wherein the U-shaped body comprises a relatively rigid core and an outer cushioning layer over the core.

3. The rest of claim 2, wherein the core is bendable or pliable to adjust the shape of the U-shaped body for a custom fit in the pocket.

4. The rest of claim 2, wherein the core has a substantially flat cross-section, and wherein the outer cushioning layer has a more rounded cross-section.

5. The rest of claim 1, wherein the U-shaped body has a pointed lower end.

6. The rest of claim 1, wherein the U-shaped body has a rounded lower end.

7. The rest of claim 1, wherein U-shaped body has a flat or squared lower end.
